(19) United States
(12) Patent Application Publication
(10) Pub. No.: US 2014/0334657 A1
(43) Pub. Date: Nov. 13, 2014

(54) PORTABLE LOUDSPEAKERS AND CONVERTIBLE PERSONAL AUDIO HEADPHONE/LOUDSPEAKERS

(71) Applicant: DR. G LICENSING, LLC, Reno, NV (US)

(72) Inventor: Godehard A. Guenther, Reno, NV (US)

(73) Assignee: DR. G LICENSING, LLC, Reno, NV (US)

(21) Appl. No.: 14/276,603

(22) Filed: May 13, 2014

Related U.S. Application Data
(60) Provisional application No. 61/922,353, filed on Dec. 31, 2013.
(60) Provisional application No. 61/822,479, filed on May 13, 2013.
(60) Provisional application No. 61/901,792, filed on Nov. 8, 2013.
(60) Provisional application No. 61/905,963, filed on Nov. 19, 2013.
(60) Provisional application No. 61/922,358, filed on Dec. 31, 2013.

(51) Int. Cl. H04R 1/10; H04R 7/04

(52) U.S. Cl. CPC H04R 1/1091; H04R 7/04; H04R 2201/10
USPC 381/370; 381/431

(57) ABSTRACT

The invention provides, in some aspects, an audio headphone suitable for conversion to a loudspeaker. The device includes one or more earcups, each having a concavity that includes first and second volumetric regions and a wall that seals the regions from one another. The first volumetric region defines a space that receives a pinnea when the headphone is worn by a user, and the second volumetric region has one or more active drivers (a/k/a “speakers”). The wall includes one or more active diaphragms of those one or more active drivers. Those diaphragms generate front waves directed into the first volumetric region and back waves directed (back) into the second volumetric region. A passive radiator that is elastically mounted in the wall passes to the first volume from the second volume at least a portion of back waves generated by one or more of the active diaphragms. The invention provides, in other aspects, portable loudspeakers constructed in a manner of the earcups described above.

This claims the benefit of filing of U.S. Patent Application No. 61/922,353, filed Dec. 31, 2013 (entitled “Convertible Personal Audio Headphone/Loudspeakers”), U.S. Patent Application No. 61/922,358, Filed Dec. 31, 2013 (entitled “Portable Loudspeaker”), U.S. Patent Application No. 61/905,963, filed Nov. 19, 2013 (entitled “Portable Loudspeaker”), U.S. Patent Application No. 61/901,792, filed Nov. 8, 2013 (entitled “Convertible Personal Audio Headphone/Loudspeakers”), U.S. Patent Application Ser. No. 61/822,479, filed May 13, 2013 (entitled “Convertible Personal Audio Headphone/Loudspeakers”).

### BACKGROUND OF THE INVENTION

The invention relates to sound reproduction and, in particular, for example, to improved personal audio devices. The invention has application, for example, in portable loudspeakers and headphones that are of improved fidelity and that are convertible to loudspeakers.

A large percentage of loudspeakers used in audio systems are electrodynamic speakers. They typically comprise drivers that are mounted within enclosures, which may be dedicated housings (such as speaker cabinets) or casings of other devices (such as PDAs) of which the speakers are a part. A driver is usually made of up a magnetic motor that moves a diaphragm to radiate sound. Traditionally, diaphragms are cone-shaped and are disposed within a frame or basket, with the wide and narrow ends of the cone coupled to the frame by way of respective flexible membranes, referred to as the suspension or surround (in the case of the wide end) and the spider (in the case of the narrow end). Those membranes keep the diaphragm axially centered while, at the same time, permitting it move back and forth at audio frequencies.

The motor is made up of a voice coil, which is usually disposed behind the narrow end of the cone, and a magnetic circuit, which is usually disposed adjacent to and/or partially surrounding the coil. In operation, electrical audio signals from an amplifier (or other source) are applied to the voice coil, producing a varying electromagnetic field. This interacts with the magnetic field of the magnet circuit, causing the voice coil to move.

Because the voice coil is coupled to the diaphragm, its movement causes the diaphragm to pump in and out—explaining why the diaphragm and coil are sometimes referred to as a “piston.” That, in turn, causes air around the diaphragm to pressurize and depressurize, producing sound waves. The enclosure prevents sound waves emitted from the rear of the diaphragm from canceling those emitted from the front. Fabric batting may be provided within the enclosure to neutralize the internally reflected sound waves and to minimize resonances. A port or passive radiator (a/k/a passive diaphragm, e.g., one mounted in a frame, but not coupled to a motor) in the front of the cabinet radiates any of the internally reflected waves not absorbed by the batting, i.e., the lower frequency waves (which are physiologically less distinguishable and, hence, when reemitted add to the overall fidelity).

Traditionally, speakers are divided into three categories: woofer, midrange and tweeter. The woofer reproduces low frequency (bass) sound ranging from about 20 to 3000 Hz. The midrange speaker reproduces a broad spectrum of sound, typically from about 1000 Hz to 10 kHz. The tweeter speaker reproduces high frequency (treble) sound ranging from about 4 to 20 k Hz. In home audio systems, the woofer, midrange and tweeter are often housed in a single enclosure, as in the case of free-standing or floor speaker configurations. Where space is a consideration, the woofer and midrange may be combined in a single speaker, as in the case with bookshelf-sized speaker configurations.

Indeed, the functions of the woofer, midrange and tweeter may all be combined into one in the case of portable or embedded loudspeakers, e.g., of the type manufactured into smart phones, PDAs, MP3 players, sound cradles, and other handheld, portable and/or electronic apparatus. Unfortunately, it is typically difficult for speakers of this type to reproduce suitably low frequencies at reasonable volumes. In fact, because sounds in the mid-range frequencies are so much more efficiently generated, they tend to dominate small or low-powered speakers, making them sound “tinny.”

Prior to the innovations of the inventor hereof, the art has largely lacked small loudspeakers capable of high fidelity sound reproduction. Prior innovations by the inventor hereof have made possible improvement in this regard. For example, according to U.S. Pat. No. 7,532,737, a low-profile, two-way loudspeaker includes a cone-shaped diaphragm and a dome-shaped (tweeter) diaphragm. A front-mounted magnetic driver comprises first and second rare earth magnets each centrally disposed within electromagnetic shielding material. The driver and cone-shaped diaphragm are mounted to a speaker frame. The tweeter diaphragm is mounted onto the driver coaxially and substantially coplanar with a forward edge of the cone-shaped diaphragm.

By way of further example, U.S. Pat. No. 8,189,840, provides loudspeakers and electronic devices with improved radiators (or “passive drivers”) comprising an elastomerically mounted mass in order to improve sound reproduction fidelity. The mass comprises a component of the device not normally used for such purpose—e.g., a battery—thereby, permitting size reductions while, at the same time, enhancing audio fidelity.

Moreover, U.S. Pat. No. 7,302,076 discloses a low-profile speaker system that has a front diaphragm that is flat-, dome- or dish-shaped situated concentrically in a shallow region or plane with a back, cone-shaped diaphragm. The two diaphragms share a common magnet structure, with the front magnet being driven by a front gap of that structure, and the back magnet diaphragm being driven by a back gap.

Prior to the innovations of the inventor hereof, the art has largely lacked small loudspeakers and, particularly, those suitable for personal use, capable of high fidelity sound reproduction. While earphone makers have had some success in that regard, it has been limited to devices designed to be fitted to users' ears and capable of reproducing sound with fidelity in volumes not substantially larger than the auricle of the ear (in the case of a so-called headphone) or the external auditory canal (in the case of an earphone, earbud or the like). Thus for example, a single earphone (or headphone) is typically unsuitable for playing sound with fidelity to two or more people, even if they are standing next to one another.

The foregoing notwithstanding, there is increased demand for loudspeakers (and/or electronic apparatus that incorporate them) with improved fidelity, smaller size and, in many instances, portability. Such are among the objects of the invention.

A related object is to provide improved headphones, loudspeakers and other audio devices.

A still further related object is to provide such improved headphones, loudspeakers and other audio devices as provide high fidelity sound.

A further related object is to provide such improved headphones that are convertible to loudspeakers and vice versa.

### SUMMARY OF THE INVENTION

Convertible Personal Audio Headphone/Loudspeakers

The foregoing objects are among those attained by the invention, which provides in some aspects an audio headphone with one or more earcups, each having a concavity that includes first and second volumetric regions and a wall that seals the regions from one another. The first volumetric region defines a space that receives a pinnea of the ear when the headphone is worn by a user, and the second volumetric region has one or more active drivers (a/k/a “speakers”).

The wall includes one or more active diaphragms of those one or more active drivers. Those diaphragms generate front waves directed into the first volumetric region and back waves directed (back) into the second volumetric region. A passive radiator that is elastically mounted in the wall radiates to the first volume from the second volume at least a portion of back waves generated by one or more of the active diaphragms.

Related aspects of the invention provide an audio headphone, e.g., as described above, in which the passive radiator is annularly shaped and is disposed, for example, about one or more of the active diaphragms. The passive radiator can, for example, be elastomeric.

Further related aspects of the invention provide an audio headphone, e.g., as described above, in which the one or more active diaphragms include a first active diaphragm and a second active diaphragm, the latter of which is mounted coaxially onto a driver of the first active diaphragm. The first active diaphragm can, according to further related aspects of the invention, be cone-shaped and the second active diaphragm can be mounted substantially coplanar with a forward edge of the first active diaphragm. The one or more active diaphragms and one or more active drivers can, according to further related aspects of the invention, form part of a two-diaphragm concentric single-magnet speaker.

Yet still further related aspects of the invention provide an audio headphone, e.g., as described above, that can be converted into a loudpeakers. The headphone includes a band that secures the one or more earcups to a head of the user. That band can, when placed on a surface, hold the one or more earcups in an upright position for use as loudspeakers. Alternatively or in addition, that band can include two detachably affixed portions, each of which, when detached from the other and placed on a surface, holds an earcup upright for use as a loudspeaker. Still further, one or more of the earcups can, alternatively or in addition, be detachably affixed to the band by mounts that, when the earcups are detached from the band, cooperate with mounts on stands that hold the one or more earcups upright for use as loudspeakers.

Related aspects of the invention provide a convertible headphone, e.g., as described above, comprising volume-limiting circuitry that is coupled to any of the active drivers and amplification circuitry therefore and that limits a volume of sound generated by diaphragms within each of the one or more earcups, when the headphone is configured to be worn by the user. For example, that circuitry can selectively apply volume limitation in response to an upright position of the one or more earcups. By way of further example, such limitation can be applied in response to a state of detachment of the two detachably affixed portions of the aforesaid band. And, by way of still further example, such limitation can be applied in response to a state of detachment of the one or more earcups from the band.

Other related aspects of the invention provide an audio headphone, e.g., as described above, comprising noise cancellation circuitry that is coupled to any of the active drivers and amplification circuitry therefore and that generates a waveform for effecting generation of noise cancelling sound by diaphragms within each of the one or more earcups. Thus, for example, back waves that are generated by one or more of the active diaphragms in response to the waveform generated by the noise cancelling circuitry and that are emitted by the passive radiator to the first volume enhance a noise cancelling capacity of front waves generated by those active diaphragms.

Other aspects of the invention provide a personal audio device constructed and operated in accord with the convertible headphone/loudspeaker discussed above.

Portable Loudspeakers

The invention provides in other aspects a loudspeaker adapted for personal and/or portable use. The loudspeaker has a body that can, for example, be puck-shaped (square, round or otherwise) and that has an inner concavity that includes a first volumetric region. A wall that is disposed within the body and that at least partially defines that region includes one or more active diaphragms.

Those diaphragms generate (i) front waves directed from the first volumetric region to at least one of an environment of the loudspeaker and a second volumetric region, if any, defined within the concavity, and (ii) back waves directed into the volumetric region. A passive radiator that is elastically mounted in the wall passes from the volumetric region at least a portion of the back waves generated by one or more of the active diaphragms.

Further aspects of the invention provide a loudspeaker, e.g., as described above, in which the active diaphragms are coupled to and driven by one or more active drivers which, themselves, are disposed in the volumetric region.

Yet still other aspects of the invention provide a loudspeaker, e.g., as described above, in which the passive radiator is annularly shaped. In related aspects of the invention, such an annularly-shaped passive radiator is disposed about one or more of the active diaphragms.

Further aspects of the invention provide a loudspeaker, e.g., as described above, in which the passive radiator is comprised of at least one of an elastomer and a sheet metal, such as brass.

Yet other aspects of the invention provide a loudspeaker, e.g., as described above, in which the one or more active diaphragms include a first active diaphragm and a second active diaphragm that is mounted coaxially onto a driver of the first active diaphragm. In a related aspect of the invention, the first active diaphragm is cone-shaped and the second active diaphragm is mounted substantially coplanar with a forward edge of the first active diaphragm. Still other related aspects of the invention provide a loudspeaker, e.g., as described above, in which the one or more active diaphragms and one or more active drivers form part of a two-diaphragm, concentric single-magnet speaker.

Still yet further aspects of the invention provide a loudspeaker, e.g., as described above, in which the one or more active diaphragms comprise first and second diaphragms coupled back-to-back with one another, the second diaphragm being cone-shaped and facing into the interior of the first volumetric region. In related aspects of the invention, the one or more active drivers comprise a voice coil at least partially disposed within a face of the cone-shaped second diaphragm.

Other aspects of the invention provide a personal audio device constructed and operated in accord with the portable loudspeaker discussed above.

The foregoing and still other aspects of the invention are evident in the text that follows and in the drawings.

### BRIEF DESCRIPTION OF THE DRAWINGS

A more complete understanding of the invention maybe attained by reference to the drawings, in which:

FIGS. 1A-1C depict an audio device according to the invention that may be converted from a headphone to a portable loudspeaker system;

FIG. 2A-2C depict the structure of earcup of the device of FIG. 1;

FIGS. 3A-3B depict a further convertible audio device according to the invention;

FIGS. 4A-4E depict a still further convertible audio device according to the invention;

FIG. 5 is a plan view of a loudspeaker suitable according to one practice of the invention; and

FIG. 6 is a cross-sectional view of a loudspeaker of the type shown in FIG. 5.

### DETAILED DESCRIPTION OF THE ILLUSTRATED EMBODIMENT

Convertible Personal Audio Headphone/Loudspeakers

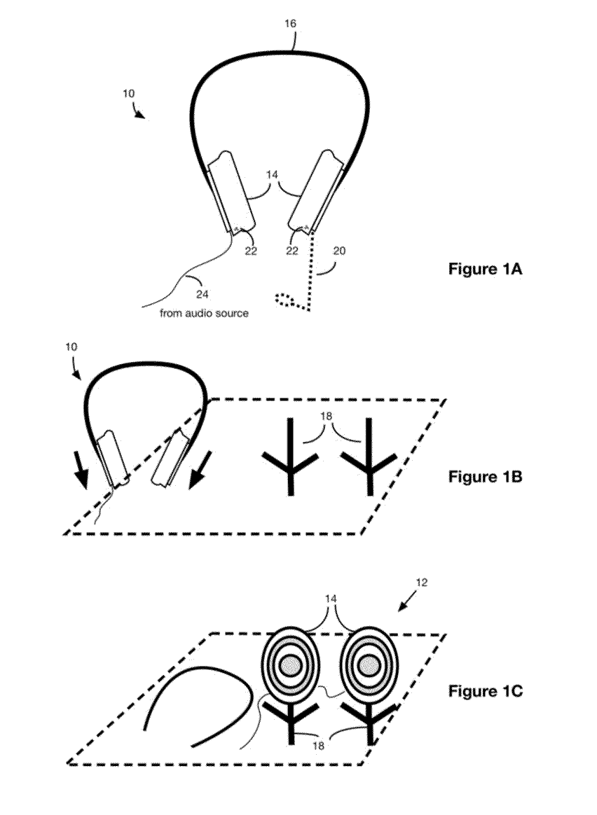

FIG. 1 depicts an audio device 10 according to one embodiment of the invention that may be converted from a headphone to a portable loudspeaker system. FIG. 1A depicts the device 10 configured as a headphone. FIG. 1C depicts the device configured as a loudspeaker. And, FIG. 1B depicts conversion of the device from a headphone to a loudspeaker.

The illustrated device 10 includes earcups 14, band 16 and, in some embodiments, can be used with stands 18. Each earcup 14 comprises a cup-shaped member or, more generally, a concave member, of the type commonly used for headphones, headsets, and the like, as adapted in accord with the teachings hereof. Although the device 10 of the illustrated embodiment is shown with two ear cups 14, some embodiments include only one.

Moreover, as suggested by the use of dashed lines in FIG. 1A, one or both of the earcups 14 may include an external microphone 20, e.g., as when the device is configured as a headset for telephony or gaming applications. Alternatively or in addition, one or both of the earcups 14 may include integrated microphones 22 for the same such applications and/or to facilitate noise cancellation. In the discussion that follows and throughout this application, the terms headphone and headset are used interchangeably, unless suggested otherwise by context.

In the embodiment of FIG. 1, the device 10 is coupled to a source of audio signals, e.g., an MP3 player, a stereo system or otherwise via conventional wiring 24, as shown. In other embodiments, the device may, instead or in addition, receive such audio signals wirelessly, e.g., via Bluetooth, WiFi or otherwise.

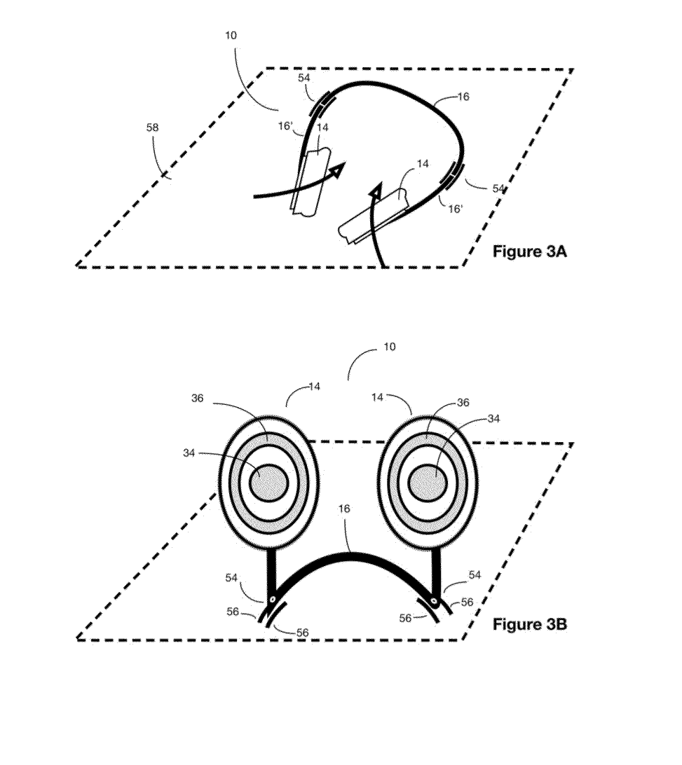

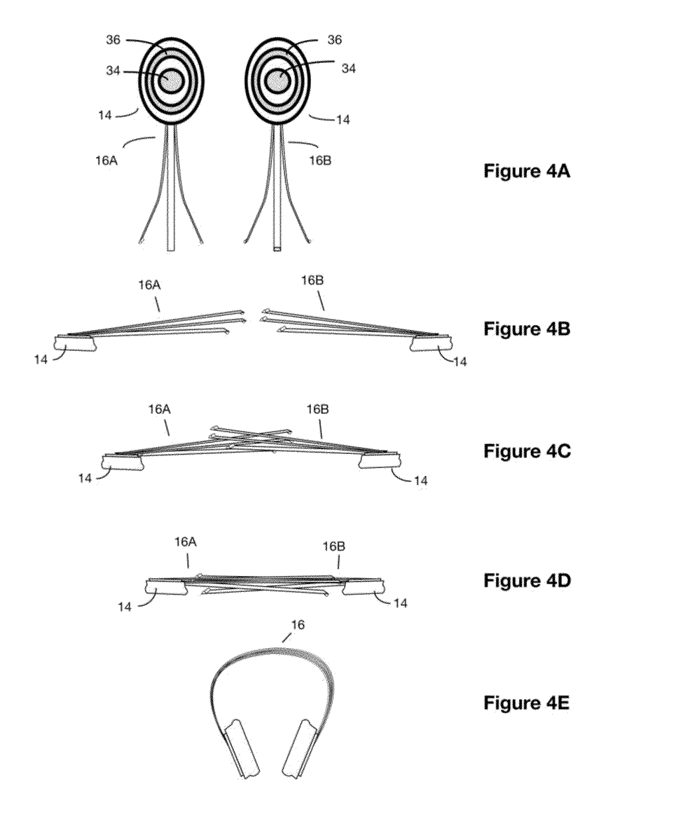

When the device 10 is configured as a headphone, as illustrated, for example, in FIG. 1A, the band 16 secures the one or more concave members (i.e. earcups) 14 to the head of the user in the conventional manner known in the art, as adapted in accord with the teachings hereof. When the device is configured as a personal loudspeaker system, the band 16 can serve as a stand to secure the cups 14 in upright position, e.g., as shown in FIGS. 3-4 and discussed below. The band 16 can also provide electrical coupling between the members/cups 14, e.g., for carrying audio signals and power between them.

Referring to FIG. 1C, in some embodiments, the device 10 can be used with stands 18 that facilitate conversion of the concave members 14 from use as earcups to use as loudspeakers. To that end, the members 14 can include mounts (not shown) that cooperate with complementary elements on the band 16 and stands 18 and that permit the members 14 to be detached from one of them (e.g., bands 16) and to be reattached to the other (e.g., stands 18), and vice a versa, depending on the particular desires of the user. Although shown here as freestanding, the stands 18 can form part of other apparatus, e.g., lamps, desktop and laptop computers, and so forth.

FIG. 1B depicts, via arrows, a direction of application of force by a user to effect detachment of members 14 from band 16 so that they can be reattached to the stands 18. Referring to FIG. 1C, once the members 14 are so attached to the stands 18, the band 16 can be put aside until it is next needed for securing the members/cups 14 to the user's head. FIG. 1C also depicts wiring used to carry audio signals and/or power between the members 14. Such wiring may not be necessary in other embodiments, e.g., which utilize Bluetooth, Wi-Fi or other wireless mechanisms to transfer such audio signals and/or in which batteries are provided in each member 14.

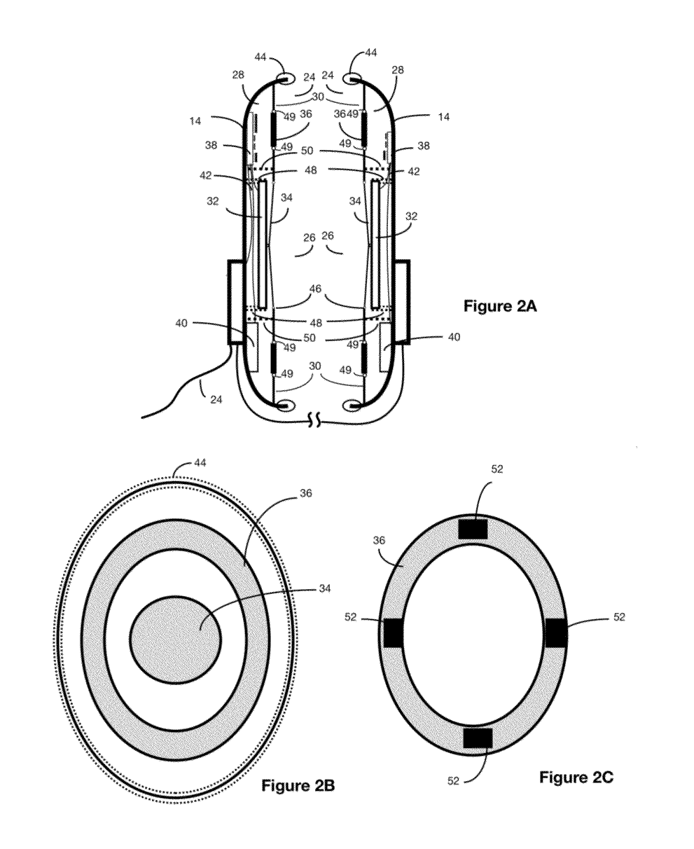

FIG. 2 is a cross-sectional view of the earcups/members 14 of the device 10 of FIG. 1. The earcups/members 14 of the illustrated embodiment are constructed and operated identically—albeit, each generates sounds for a respective channel of the audio signal received by device 10, e.g., via wiring 24 or otherwise. An exemplary such earcup/member 14 is discussed below.

Those skilled in the art will appreciate that in other embodiments, the earcups/members 14 are constructed differently from one another. Thus, for example, only one of them may have a battery 40, and wiring (not shown) traveling between the two earcups/members 14 may carry power from it to the other earcup/member 14. Likewise, by way of further example, the circuitry 38 may differ as between the earcups/members 14, e.g., as where the circuitry 38 of one earcup/member 14 serves one set of functions (such as, for example, digital signal processing) and the circuitry of the other earcup/member 14 serves another set of functions (such as, for example, stereo amplification)—likewise, with wiring (not shown) running between the two earcups/members 14 to carry the necessary signaling for those functions. Indeed, in some embodiments, circuitry 38 is provided in only one of the earcups/members 14 and serves all of those functions.

As shown in FIG. 2, earcup/member 14 comprises a generally concave body that can be fabricated from wood, metal, epoxies, polymers or other solid materials. Preferred such materials, which are lightweight and durable, include thermosetting plastics. Some embodiments utilize bodies made from carbon fiber-reinforced PEEK (polyether ether ketone) or PI (polyimide) polymers. By way of example, the earcups/members 14 can be injection-molded carbon fiber domes.

The earcup/member 14 has a concavity (i.e., a hollow, a cavity, a hollow surface or side) 24 that includes a first volumetric region 26, a second volumetric region 28, wall 30, active drivers 32, active diaphragms 34 and passive radiator 36, all generally disposed as shown and described below. Each ear-cup/member 14 can further include circuitry 38, battery 40, wiring 42, and gaskets 44, 46.

The first volumetric region 26 defines a space that receives an ear, and, more particularly, the pinnea of the ear, when the headphone is worn by a user. In this regard, the volumetric region 26 can be sized and shaped in accord with conventional practice of the headphone-making art. The size and shape of that volume is defined, in part, by gasket 44, which can be fabricated from plastic-coated foam or other material or combination thereof. And, it is defined, in part, by portions of the outer edges of the earcup/members 14 peripheral to wall 30 (i.e., those edges to which the foam gasket 44 is attached). Given the dual roles of device 10, the first volumetric region 26, including gasket 44, can be sized and shaped not only to accommodate the users ear when the device is worn as headphone, but also preferably to amplify (e.g., in the manner of a horn loudspeaker) sound emitted by the diaphragms 34, 36 when the device 10 is used as a loudspeaker. In this letter regard, the edges of the earcups/members 14 and gasket 44 defining walls of the first volumetric region can be at least generally conically shaped.

The second volumetric region 28 defines a space in which active drivers 32 can reside and in which back waves generated by the active diaphragms 34 are captured and reflected for transmission via passive radiator 36. In these regards the region 28 serves, at least in part, in the manner of the enclosure portion of a more traditional loudspeaker. That size and shape, which is defined, in part, by the position of the wall 30 within the concavity, as well as by the shape of that portion of the concavity “behind” that wall (i.e., furthest from the ear when the device 10 is worn as a headphone) can be shaped in accord with conventional practice of the headphone-making art, taking into account (to the extent afforded by weight and other design constraints) the dual role of the device 10 as a loudspeaker.

The wall 30 divides the two volumetric regions 26, 28 and seals them from one another. In the illustrated embodiment, the seal is hermetic in order to minimize transmission of back waves generated by the active diaphragm 34 other than via passive radiator 36. In other embodiments, The seal is “lossy” and, thereby, permits transmission of at least some of those waves, directly, through the passage of air between the volumes 26, 28. The wall 30 can be fabricated from the materials discussed above in connection with the body of earcups/members 14. The wall 30 may be mounted in a frame 50 integral and/or affixed to the body of the respective cup/member 14 at the inside of the concavity 24 or otherwise.

Disposed in wall 30 are one or more active diaphragms 34, each coupled to and reciprocated (or otherwise driven) by respective active drivers 32. Seals 46 can help secure the diaphragms 34 within the wall 30, as well as provide hermetic sealing therefor.

Though a single diaphragm 34 and driver 32 can be utilized on each earcup/member 14, the illustrated embodiment employs a concentric pair of such diaphragms 34 and drivers 32 in each cup/member 14. Regardless of their number and configuration, the diaphragms 34 and drivers 32 can be of the type known in the art for use with headphones and/or personal audio systems. Preferred diaphragms and drivers are of the type disclosed and/or claimed in the many patents and patent applications assigned to the assignee hereof and, still more preferably, for example, in those disclosed and/or claimed in aforementioned U.S. Pat. Nos. 7,532,737 and 7,302,076 the teachings of which are incorporated herein by reference. In other embodiments of the invention the driver 32 and diaphragms 34 are configured and operated in the manner of the three-part piston described in U.S. Pat. No. 8,526,660, i.e., a three-part piston having first and second active diaphragms coupled back-to-back, with one of the diaphragms facing outwardly (i.e., through the first volumetric region 26 and outward of the concavity 24) and the other diaphragm facing inward (i.e., into the interior of the volumetric region 28), and having an active driver 32 with a voice coil that is face-mounted within the inward-facing diaphragm.

The driver(s) 32 may, themselves, be disposed in second volumetric region 28, e.g., immediately “behind” the respective diaphragm(s) 34 or otherwise. They may be mounted in a frame 48 integral and/or affixed to the body of the respective cup/member 14 at the inside of the concavity 24 or otherwise.

The driver(s) 32 reciprocate (or otherwise drive) the respective active diaphragm(s) which, in turn, cause air around them to pressurize and depressurize, effecting (i) frontward-directed sound waves, i.e., “front waves,” moving in the direction from the wall 30 to through the first volumetric region 26 and outward of the concavity 24 (e.g., if not blocked by the users' pinnea, head and/or otherwise), and (ii) rearward-directed waves, i.e., back waves, that radiate into second volumetric region 28.

The back waves are reflected by internal surfaces within the second volumetric region 28, e.g., inner walls of concavity 24, frames 48, 50, and so forth. Fabric batting, not shown, can be provided in that second volumetric region 28 to attenuate higher frequencies within those back waves, minimizes internal reflections and reduces resonances. A foam member of the type disclosed for use in loudspeakers and other handheld, portable and/or electronic apparatus in copending, commonly assigned U.S. patent application Ser. No. 13/557,410, filed Jul. 25, 2012, and corresponding International Publication number WO2013016375, both entitled “Ultra-Low Profile Loudspeakers,” and, more specifically, by way of nonlimiting example, as element 34 in FIGS. 2A and 2B thereof, and the accompanying text, the teachings of which application, figures and text are incorporated herein by reference, can be used instead of or in addition to such fabric batting.

Passive radiator 36, which is disposed in wall 30, radiates frontward, as further front waves, those back waves internally reflected within the second volumetric region 28 not absorbed by the fabric batting or otherwise. Seals 49 can help secure the passive radiator 36 within the wall 30, as well as provide hermetic sealing therefor. Alternatively or in addition, the passive radiator 36 can be overmolded or otherwise secured to the wall 30.

The passive radiator 36 can comprise a rubber or other elastomeric sheet, sized and sealed, e.g., via elements 56 to the wall 30. Alternatively, or in addition, it can comprise such an elastomeric member that is overmolded onto the wall 30. Passive radiator 36 is not limited to elastomeric compounds and other materials suitable for radiating frontward, as further front waves, back waves internally reflected within the second volumetric region 28 can be used instead or in addition. By way of nonlimiting example, in some preferred embodiments, the radiator 36 is fabricated, in whole or part, from a sheet of brass or other metal, which can be coated, e.g., with an elastomer or otherwise on one or both (e.g., proximal and/or distal) sides.

The passive radiator 36 can further comprise, in addition to such a elastomeric or other materials, one or more masses of the type used with the passive radiator disclosed in commonly-assigned U.S. patent application Ser. No. 11/752,400, Pub. No. US 2008/0292117 (now, U.S. Pat. No. 8,189,840), entitled “Improved Loudspeaker and Electronic Devices Incorporating Same,” and, more specifically, e.g., in FIG. 2B of that patent application, and in the accompanying text, the teachings of which patent application, figure and text are incorporated herein by reference.

As evident there, such a mass can be a battery 40 or other component of the device not normally used for such purpose. However, as in the illustrated embodiment of the present application, that mass may instead or in addition comprise inert pieces of rubber, ceramic, metal, plastic, wood or so forth, all by way of nonlimiting example. A single such mass may be used, as may multiple such masses 52 distributed for example about the passive radiator 36 in the manner shown for example in FIG. 2C hereof.

The passive radiator 36 of the illustrated embodiment is annularly shaped, e.g., as shown in FIGS. 2B and 2C. It is, moreover, disposed about one or more of the active diaphragms, as shown in FIGS. 2A and 2B. In other embodiments, the passive radiator 36 may be shaped otherwise and multiple passive radiators 36 may be provided in wall 30 of the same or varying shapes.

In some embodiments, the passive radiator 36 has a mass of about 2 to 30 times that (of the combined mass) of the active diaphragm(s) 34 and, preferably, 10 to 20 times that (of the combined mass) of the active diaphragm(s) 34 and, still more preferably, 10 times that (of the combined mass) of the active diaphragm(s) 34. Thus, for example, if the active diaphragm(s) 34 has/have a combined weight of 1 gram, the annular passive diaphragm 36 has a weight of 10 grams. Likewise, in some embodiments, the passive radiator 36 has a surface area of about 1 to 5 times that (of the combined surface area) of the active diaphragm(s) 34 and, preferably, about 2 times that (of the combined surface area) of the active diaphragm(s) 34. The aforesaid comparative masses and surface areas of the passive radiator 36 and active diaphragm(s) 34 are with respect to the moving components of the radiator 36 and diaphragm(s) 34, respectively, and, thus, may include seals 46, 49 or other components that are affixed to the radiator 36 and diaphragm(s) 34 and that move therewith when sound is radiated thereby.

Circuitry 38 conditions the audio signal received by the device 10, e.g., via leads 24. That conditioning includes amplification, band-pass filtering, smoothing and so forth, as is common in the art. The circuitry 38 is preferably powered via a battery 40, though, it can be powered otherwise, e.g., via external sources (e.g., power from the battery of another earcups/members 14 or from an external source).

In preferred embodiments, the circuitry 38 includes volume-limiting logic that is coupled to amplification logic (not shown) of that same circuitry 38 and, thereby, indirectly to the active drivers 32 in order to limit a volume of sound generated by the diaphragms 34, 36 when the device 10 is configured as a headphone and is being worn by a user. To that end, the volume-limiting circuitry can be activated by a proximity sensor (not shown) that utilizes photocells, capacitive sensors and/or other such technology to determine when the device 10 is so worn. It can, instead or in addition, be activated by mechanical, electromechanical, magnetic and/or other switches that are coupled to band 16 and that reflect whether the device 10 is in its headphone configuration or its loudspeaker configuration (e.g., as indicated by whether the device 10 is in an upright, loudspeaker configuration, whether detachable portions of the band 16 are affixed to one another and/or whether detachable earcups/members 14 are fixed to the band 16, all by way of non-limiting example).

In these and/or other preferred embodiments, the circuitry 38 can include noise-cancellation logic of the type known in the art, albeit, as adapted in accord with the teachings hereof. That logic can utilize information regarding the ambient sound provided by integrated microphone 22 to drive to the amplification logic and, thereby, to the active drivers 32 for reproduction via active diaphragms 34 waveforms canceling that ambient sound. When combined with the enhanced bass reproduction offered by passive radiators 36, the resultant sound cancellation is superior to that offered by prior art headphones.

Batteries 40 maybe lithium polymer batteries of the type commercially available in the marketplace or other batteries suitable for use in the device 10 described herein.

FIG. 3 depicts another embodiment of the audio device 10 of FIG. 1, albeit, here, where the band 16 serves as a stand for the device 10 when it is in the loudspeaker configuration. FIG. 3A depicts the device 10 in a headphone configuration; FIG. 3B depicts it in loudspeaker configuration.

Referring to those drawings, it can be seen at the band 16 includes hinge members 54 that permit rotation of the distal ends 16′ of the band 16 and the earcups/members 14 that are attached to those distal ends 16′ to rotate out of the plane 58 defined by the remainder of the band (i.e., its central body). Referring to FIG. 3B, the hinge members include feet 56 that remain aligned with the plane 58 and, thereby, provide greater stability when the distal ends 16′ of the band and the earcups/members 14 are rotated so as to place the device 10 in the loudspeaker configuration.

FIG. 4 depicts yet another embodiment of the audio device 10 of FIG. 1, albeit, here, where the band 16 includes interlocking halves 16a, 16b, each of which serves as a stand for the respective earcups/members 14 as shown in FIG. 4A. With further reference to that drawing, it will be seen that each such half 16a and 16b, itself, comprises three legs (though, greater or lesser number could be employed), each of generally elongate structure and of sufficient stiffness as to hold the respective earcups/members 14 upright, as shown in that drawing.

At the same time, those legs are sufficiently flexible to permit they are being pushed together and interlocked in the manners shown in FIGS. 4B-4D in order to form a band 16 as shown in FIG. 4E.

Portable Loudspeakers

Described below are portable loudspeakers constructed in accord with the teachings above vis-à-vis the earcups/members 14, albeit, not necessarily adapted for use as headphones. Parallels between the earcups/members 14 and the portable speakers below are evident in the similarities of the text below and in the use of reference numerals that are like other than in the use of hundreds digits. To the end, the teachings above the teachings with respect to convertible headphones/loudspeakers (and, particularly, the ear cups/members 14 thereof) above can be applied to the portable loudspeakers below, and vice versa.

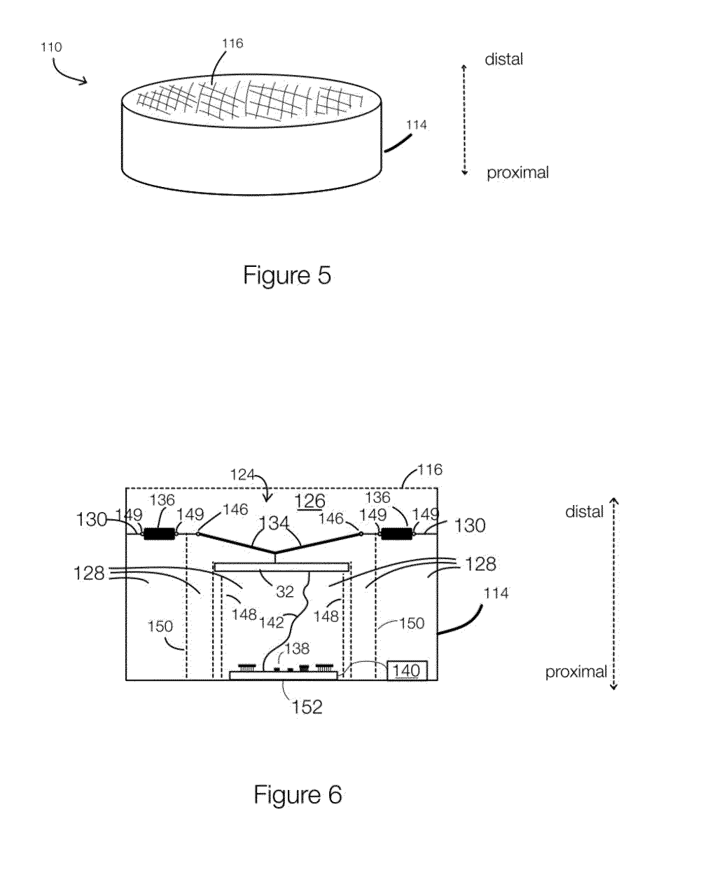

FIG. 5 depicts a loudspeaker 110 according to one aspect of the invention. The illustrated loudspeaker 110 includes a body 114 and a grill 116 generally arranged as shown. In the embodiment of FIG. 5, the device 110 is coupled to a source of audio signals, e.g., an MP3 player, a stereo system or otherwise via conventional wiring 124, as shown. In other embodiments, the device may, instead or in addition, receive such audio signals wirelessly, e.g., via Bluetooth, WiFi or otherwise.

The body 114 of illustrated loudspeaker 110 is generally puck-shaped, e.g., a squat structure of round, square or other-shaped cross section (though in other embodiments it may of tower-like, pillow-like or other configuration) and is sized for personal and/or portable use. Thus, for example, it can be sized and/or shaped to sit on a tabletop or to sit or be affixed to some other surface and/or structure (e.g., a tablet or laptop computer or otherwise). Body 114 can be fabricated from glass, ceramic, wood, metal, epoxies, polymers, other materials (and/or a combination of the foregoing) selected, for example, based on intended uses of the loudspeaker 110. Preferred such materials, which are lightweight and durable, include thermosetting plastics. Some embodiments utilize bodies made from carbon fiber-reinforced PEEK (polyether ether ketone) or PI (polyimide) polymers. By way of example, the the body 114 can be injection-molded carbon fiber domes.

In the illustrated embodiment, the body 114 is generally of unibody construction, e.g., comprising a single cast, molded, blown or other piece suitable for encasing the loudspeaker's constituent components under expected use conditions. In other embodiments, the body 114 may be a multipart fabrication that includes, for example, a base portion, a top portion and/or a stand/mounting adapter (one or more of which may serve, for example, as a heat sink), all by way of nonlimiting example.

The grill 16, which is not utilized in some embodiments, is a wire mesh, fabric, foam or other covering suitable for visually, mechanically, electrically, environmentally and/or otherwise shielding the content of loudspeaker 110 and/or for enhancing its appearance. The illustrated grill 116 minimally attenuates sound emitted by the loudspeaker 116, though, in other embodiments the grill 116 provide bandwidth-based or other attenuation, augmentation or otherwise.

FIG. 6 is a cross-sectional view of a loudspeaker of the type shown in FIG. 5. As shown in FIG. 6, the interior of body 114 defines a concavity 124 that includes a proximal volumetric region 128 defining a space in which active driver 132 can reside and in which back waves generated by the active diaphragm 134 are captured and reflected (by the interior of body 114 and componentry therein) for transmission to the listener via passive radiator 136 (and grill 116). In these regards the region 128 serves, at least in part, in the manner of the enclosure portion of a more traditional loudspeaker. Its size and shape, which are defined, in part, by the position of the wall 130 within the concavity 124, as well as by the portion of the concavity proximal to the mounting adapter 112, can be adapted (to the extent afforded by other design constraints) to the device 110 as a loudspeaker.

The wall 130 is disposed at the distal end of the volumetric region 128 and seals that region from (i) a distal region 126 defined within the concavity 124 and/or the grill 116, as shown, and/or (ii) the environment surrounding the loudspeaker 110. In the illustrated embodiment, the seal is hermetic in order to minimize transmission of back waves generated by the active diaphragm 134 other than via passive radiator 136. In other embodiments, the seal is lossy and, thereby, permits transmission of at least some of those waves, directly, through the passage of air from the volume 128 to the region 126 and/or environment. The wall 130, which may be mounted in frame members 150 integral, affixed within the body 114 at the inside of the concavity 124 or otherwise, can be fabricated from the materials discussed above in connection with the body 114 or otherwise.

Disposed in wall 130 are one or more active diaphragms 134, each coupled to and reciprocated (or otherwise driven) by respective active drivers 132. Seals 146 can help secure the diaphragms 134 within the wall 130, as well as provide hermetic sealing therefor.

Though a single diaphragm 134 and driver 132 can be utilized, the illustrated embodiment employs a concentric pair of such diaphragms 134 and drivers 132 in body 114. Regardless of their number and configuration, the diaphragms 134 and drivers 132 can be of the type known in the art for use with headphones and/or personal audio systems. Preferred diaphragms and drivers are of the type disclosed and/or claimed in the many patents and patent applications assigned to the assignee hereof and, still more preferably, for example, in those disclosed and/or claimed in aforementioned U.S. Pat. Nos. 7,532,737 and 7,302,076, the teachings of which are incorporated herein by reference. In other embodiments of the invention the driver 132 and diaphragms 134 are configured and operated in the manner of the three-part piston described in U.S. Pat. No. 8,526,660, i.e., a three-part piston having first and second active diaphragms coupled back-to-back, with one of the diaphragms facing outwardly (i.e., toward the exterior of the loudspeaker 110) and the other diaphragm facing inward (i.e., into the interior of the volumetric region 128), and having an active driver 132 with a voice coil that is face-mounted within the inward-facing diaphragm.

The driver(s) 132 may, themselves, be disposed in proximal volumetric region 128, e.g., immediately “behind” the respective diaphragm(s) 134 or otherwise. They may be mounted in a frame 148 integral and/or affixed to the body 114 at the inside of the concavity 124, and they may receive power via wiring 142, as shown. In some embodiments, the driver(s) are mounted on a printed circuit board 152 on which circuitry 138 and/or other electronic componentry of loudspeaker 10 is/are disposed.

The driver(s) 132 reciprocate (or otherwise drive) the respective active diaphragm(s) 134 which, in turn, cause air around them to pressurize and depressurize, effecting (i) frontward-directed (or outward-directed) sound waves, i.e., “front waves,” moving in the direction from the wall 130, through the distal volumetric region 126 (if present), and outward of the concavity 124, and (ii) rearward-directed waves (or inward-directed), i.e., back waves, that radiate into proximal volumetric region 128.

The back waves are reflected by internal surfaces of the proximal volumetric region 128, e.g., inner walls of concavity 124, frames 148, 150, within the region 128, and so forth. Fabric batting, not shown, can be provided in proximal volumetric region 128 to attenuate higher frequencies within those back waves, minimize internal reflections and reduce resonances. A foam member of the type disclosed for use in loudspeakers and other handheld, portable and/or electronic apparatus in copending, commonly assigned U.S. patent application Ser. No. 13/557,410, filed Jul. 25, 2012, and corresponding International Publication number WO 2013016375, both entitled “Ultra-Low Profile Loudspeakers,” and, more specifically, by way of nonlimiting example, as element 34 in FIGS. 2A and 2B thereof, and the accompanying text, the teachings of which application, figures and text are incorporated herein by reference, can be used instead of or in addition to such fabric batting.

Passive radiator 136, which is disposed in wall 130, radiates frontward, as further front waves, those back waves internally reflected within the proximal volumetric region 128 not absorbed by the fabric batting, foam or otherwise. Seals 149 can help secure the passive radiator 136 within the wall 130, as well as provide hermetic sealing therefor. Alternatively or in addition, the passive radiator 36 can be overmolded or otherwise secured to the wall 130.

The passive radiator 136 of the illustrated embodiment is annularly shaped and is disposed about the active diaphragm(s) 134, e.g., as shown in FIG. 6. In other embodiments, the passive radiator 136 may be shaped otherwise and multiple passive radiators 136 may be provided in wall 130 of the same or varying shapes.

The passive radiator 136 can comprise a rubber or other elastomeric sheet, sized and sealed, e.g., to the wall 130. Alternatively, or in addition, it can comprise such an elastomeric member that is overmolded onto the wall 130. Passive radiator 136 is not limited to elastomeric compounds, and other materials suitable for radiating frontward, as further front waves, back waves internally reflected within the proximal volumetric region 128 can be used instead or in addition. By way of nonlimiting example, in some preferred embodiments, the radiator 136 is fabricated, in whole or part, from a sheet of brass or other metal, which can be coated, e.g., with an elastomer or otherwise on one or both (e.g., proximal and/or distal) sides.

The passive radiator 136 can further comprise, in addition to such a elastomeric and/or other materials, one or more masses of the type used with the passive radiator disclosed in commonly-assigned U.S. Pat. No. 8,189,840, entitled “Improved Loudspeaker and Electronic Devices Incorporating Same,” and, more specifically, e.g., in FIG. 2B of that patent and in the accompanying text, the teachings of which patent, figure and text are incorporated herein by reference. As evident there, such a mass can be a battery 140 or other component of the device not normally used for such purpose.

However, as in the illustrated embodiment of the present application, that mass may instead or in addition comprise inert pieces of rubber, ceramic, metal, plastic, wood or so forth, all by way of nonlimiting example. A single such mass may be used, as may multiple such masses 156 distributed for example about the passive radiator 136.

In some embodiments, the passive radiator 136 has a mass of about 2 to 30 times that (of the combined mass) of the active diaphragm(s) 134 and, preferably, 10 to 20 times that (of the combined mass) of the active diaphragm(s) 134 and, still more preferably, 10 times that (of the combined mass) of the active diaphragm(s) 134. Thus, for example, if the active diaphragm(s) 134 has/have a combined weight of 1 gram, the annular passive diaphragm 136 has a weight of 10 grams. Likewise, in some embodiments, the passive radiator 136 has a surface area of about 1 to 5 times that (of the combined surface area) of the active diaphragm(s) 134 and, preferably, about 2 times that (of the combined surface area) of the active diaphragm(s) 134. The aforesaid comparative masses and surface areas of the passive radiator 136 and active diaphragm(s) 134 are with respect to the moving components of the radiator 36 and diaphragm(s) 134, respectively, and, thus, may include seals 146, 149 or other components that are affixed to the radiator 136 and diaphragm(s) 134 and that move therewith when sound is radiated thereby.

Circuitry 138 conditions the audio signal received by the device 10, e.g., via remote transmission from a radio receiver, stereo, MP3 player or other audio source (not shown). That conditioning includes amplification, band-pass filtering, smoothing and so forth, as is common in the art. The circuitry 38 can be powered via a battery or otherwise.

### CONCLUSION

Describe above are devices and methods meeting the aforementioned objects, among others. It will be appreciated that the embodiments shown in the drawings and described here are merely examples of the invention and that other embodiments incorporating changes thereto fall within the scope of the invention.

1. An audio headphone comprising,
one or more earcups, each including
i. a concavity that includes
a. a first volumetric region and a second volumetric region,
b. a wall that seals the first volumetric region from the second volumetric region,
c. the first volumetric region defining a space that receives a pinnea when the headphone is worn by a user,
d. the second volumetric region including one or more active drivers and,
e. the wall including one or more active diaphragms of one or more active drivers, the one or more active diaphragms generating front waves directed into the first volumetric region and back waves directed into the second volumetric region,
ii. a passive radiator elastically mounted in the wall that passes to the first volume from the second volume at least a portion of back waves generated by one or more of the active diaphragms.

2. The audio headphone of claim 1, wherein the passive radiator is annularly shaped.

3. The audio headphone of claim 2, wherein the passive radiator is disposed about one or more of the active diaphragms.

4. (canceled)

5. The audio headphone of claim 1, wherein the one or more active diaphragms include a first active diaphragm and a second diaphragm that is mounted onto coaxially onto a driver of the first active diaphragm.

5. (canceled)

7. The audio headphone of the claim 1, with the one or more active diaphragms and one or more active drivers form part of a two-diaphragm concentric single-magnet speaker.

8. The audio headphone of claim 1, including a band that secures the one or more earcups to a head of the user.

9-11. (canceled)

12. The audio headphone of claim 8, comprising volume-limiting circuitry that is coupled to any of the active drivers and amplification circuitry therefore and that limits a volume of sound generated by diaphragms within each of the one or more earcups when the headphone is configured to be worn by a said user.

13-15. (canceled)

16. The audio headphone of claim 1, comprising noise cancellation circuitry that is coupled to any of the active drivers and amplification circuitry therefore and that generates a waveform for effecting generation of noise cancelling sound by diaphragms within each of the one or more earcups.

17. (canceled)

18. An personal audio device, comprising,
A. one or more concave members, each including
i. a first volumetric region and a second volumetric region,
ii. a wall that seals the first volumetric region from the second volumetric region,
iii. the first volumetric region defining a space that receives a pinnea when the headphone is worn by a user,
iv. the second volumetric region including one or more active drivers and,
v. the wall including one or more active diaphragms of one or more active drivers, the one or more active diaphragms generating front waves directed into the first volumetric region and back waves directed into the second volumetric region,
vi. a passive radiator elastically mounted in the wall that passes to the first volume from the second volume at least a portion of back waves generated by one or more of the active diaphragms,
B. a band that alternatively secures the one or more concave members to a head of the user and secures the one or more concave members in upright position for use as loudspeakers.

19. A loudspeaker, comprising,
A. a body having a concavity that includes a first volumetric region,
B. a wall that is disposed within the body and that at least partially defines the first volumetric region,
C. the wall including one or more active diaphragms that are coupled to one or more active drivers, the one or more active diaphragms generating
front waves directed from the first volumetric region to at least one of an environment and a second volumetric region, if any, defined within the concavity, and
back waves directed into the volumetric region,
D. a passive radiator elastically mounted in the wall that passes from the volumetric region at least a portion of back waves generated by one or more of the active diaphragms, wherein the passive radiator is annularly shaped.

20. The loudspeaker of claim 19, wherein the one or more active drivers are disposed in the first volumetric region.

21. The loudspeaker of claim 19, wherein the body is puck-shaped.

22. The loudspeaker of claim 19, wherein the passive radiator is formed from a metal.

23-25. (canceled)

26. The loudspeaker of claim 19, wherein the one or more active diaphragms include a first active diaphragm and a second diaphragm that is mounted onto coaxially onto a driver of the first active diaphragm.

27. (canceled)

28. The loudspeaker of the claim 19, with the one or more active diaphragms and one or more active drivers form part of a two-diaphragm concentric single-magnet speaker.

29. (canceled)

30. The loudspeaker of claim 19, wherein the passive radiator is formed of a metal.

31. (canceled)

32. The loudspeaker of claim 19, wherein the passive radiator is formed of brass.

33. The loudspeaker of claim 19, wherein the one or more active diaphragms comprise first and second diaphragms coupled back-to-back with one another, the second diaphragm being cone-shaped and facing into the interior of the first volumetric region.

34. (canceled)

35. The loudspeaker of claim 19, wherein the one or more active diaphragms include a first active diaphragm and a second diaphragm that is mounted onto coaxially onto a driver of the first active diaphragm.

36. (canceled)

37. The loudspeaker of the claim 19, with the one or more active diaphragms and one or more active drivers form part of a two-diaphragm concentric single-magnet speaker.
